(19) United States
(12) Patent Application Publication
(10) Pub. No.: US 2007/0047495 A1
(43) Pub. Date: Mar. 1, 2007

(54) Reverse link soft handoff in a wireless multiple-access communication system

(75) Inventors: Tingfang Ji, San Diego, CA (US); Mohammad J. Borran, San Diego, CA (US)

Correspondence Address: QUALCOMM INCORPORATED, 5775 MOREHOUSE DR., SAN DIEGO, CA, 92121, US

(73) Assignee: QUALCOMM Incorporated

(21) Appl. No.: 11/261,159

(22) Filed: Oct. 27, 2005

Related U.S. Application Data
(60) Provisional application No. 60/712,486, filed on Aug. 29, 2005.
(60) Provisional application No. 60/724,004, filed on Oct. 6, 2005.

(51) Int. Cl. H04B 7/216

(52) U.S. Cl. 370/335

(57) ABSTRACT

A terminal communicates with a serving base station and at least one soft handoff (SHO) base station for soft handoff on the reverse link in a wireless communication system. In one design, the serving base station schedules the terminal for transmission on the reverse link, forms an assignment for the terminal, and generates signaling for the terminal. The assignment indicates communication parameter(s) to be used by the terminal for transmission on the reverse link. The signaling contains sufficient information to allow the SHO base station(s) to receive and process the transmission from the terminal. The serving base station sends the signaling via a backhaul to the SHO base station(s). Each SHO base station receives the signaling via the backhaul, receives the transmission from the terminal via the reverse link, and processes the transmission in accordance with the signaling to recover the data sent in the transmission.

### CLAIM OF PRIORITY UNDER 35 U.S.C. §119

The present application claims priority to provisional U.S. Application Ser. No. 60/712,486, entitled “Reverse Link Soft Handoff and Decoding in Orthogonal Frequency Division Multiple Access Communication Systems,” filed Aug. 29, 2005, and U.S. application Ser. No. 60/724,004, entitled “Reverse Link Soft Handoff in A Wireless Communication System,” filed Oct. 6, 2005, both of which are assigned to the assignee hereof and incorporated herein by reference in their entireties.

I. Reference to Co-Pending applications for patent

The present application for patent is related to the following co-pending U.S. patent applications:

“Puncturing Signaling Channel For A Wireless Communication System” having Attorney Docket No. 060058, filed concurrently herewith, assigned to the assignee hereof, and expressly incorporated by reference herein; and

“Mobile Wireless Access System” having Attorney Docket No. 060081, filed concurrently herewith, assigned to the assignee hereof, and expressly incorporated by reference herein.

### BACKGROUND

I. Field

The present disclosure relates generally to communication, and more specifically to techniques for transmitting data in a wireless communication system.

II. Background

A wireless multiple-access communication system may concurrently support communication for multiple terminals on the forward and reverse links. The forward link (or downlink) refers to the communication link from the base stations to the terminals, and the reverse link (or uplink) refers to the communication link from the terminals to the base stations. Multiple terminals may simultaneously transmit data on the reverse link and/or receive data on the forward link. This may be achieved by multiplexing the transmissions on each link to be orthogonal to one another in time, frequency, and/or code domain. The orthogonality ensures that the transmission for each terminal minimally interferes with the transmissions for the other terminals.

A communication system may support soft handoff, which is a process in which a terminal communicates with multiple base stations simultaneously. For soft handoff on the forward link, multiple base stations concurrently transmit data to the terminal, which may combine the transmissions from these base stations to improve performance. For soft handoff on the reverse link, the terminal transmits data to multiple base stations, which may independently decode the transmission from the terminal. Alternatively, a designated base station or network entity may combine the transmissions received by the multiple base stations and decode the combined output. For both the forward and reverse links, soft handoff provides spatial diversity against deleterious path effects since data is transmitted to or from multiple base stations at different locations.

For soft handoff on the forward link, each base station consumes air-link resources to transmit to a terminal. The air-link resources may be quantified by frequency, time, code, transmit power, and/or some other quantity. For soft handoff on the reverse link, a terminal typically consumes the same amount of air-link resources to transmit to one or multiple base stations. Hence, soft handoff on the reverse link is especially desirable since the main cost of providing reverse link soft handoff is additional processing at the base stations.

In some communication systems, the manner in which a terminal transmits data on the reverse link may be fixed and/or known a priori by all base stations supporting soft handoff for the terminal. In such systems, soft handoff on the reverse link may be readily supported since each base station knows when and how to receive the transmission from the terminal. However, in some communication systems, the manner in which a terminal transmits data on the reverse link may not be fixed and/or may not be known a priori by all base stations supporting soft handoff. In such systems, not all base stations may know when and how to receive the transmission from the terminal. Nevertheless, it is desirable to support soft handoff on the reverse link in such systems in order to improve performance without consuming additional air-link resources.

There is therefore a need in the art for techniques to support soft handoff in a communication system.

### SUMMARY

Techniques for supporting soft handoff on the reverse link in a wireless multiple-access communication system are described herein. The techniques may be used for an orthogonal frequency division multiple access (OFDMA) system, a single-carrier frequency division multiple access (SC-FDMA) system, a code division multiple access (CDMA) system, a time division multiple access (TDMA) system, a frequency division multiple access (FDMA) system, and so on. A terminal communicates with a serving base station and at least one soft handoff (SHO) base station, which are defined below, for soft handoff on the reverse link.

In an aspect, the serving base station schedules the terminal for transmission on the reverse link, forms an assignment for the terminal, and generates signaling for the terminal. The assignment indicates at least one parameter to be used by the terminal for transmission on the reverse link such as, e.g., a time and frequency allocation for the terminal, the coding and modulation to be used by the terminal, and so on. The signaling contains sufficient information to allow the SHO base station(s) to receive and process the transmission from the terminal. The signaling may contain, e.g., the assignment. The serving base station sends the assignment to the terminal and sends the signaling via a backhaul to the SHO base station(s). Thereafter, the serving base station receives the transmission from the terminal via the reverse link and processes the transmission in accordance with the assignment.

Each SHO base station receives the signaling via the backhaul, receives the transmission from the terminal via the reverse link, and processes the transmission in accordance with the signaling to recover the data sent in the transmission. The processing may be performed in various manners depending on whether the signaling is received before or after arrival of the transmission, whether a received signal for the SHO base station is buffered, whether the transmission from the terminal is an H-ARQ transmission, and so on, as described below.

Each base station may generate an acknowledgment (ACK) for the transmission if it is decoded correctly. Each base station may send the ACK to the terminal and may also send the ACK via the backhaul to the other base station(s) supporting soft handoff for the terminal.

In another aspect, the terminal sends signaling to allow the SHO base station(s) to recover the transmission from the terminal. Various aspects and embodiments of the invention are described in further detail below.

### BRIEF DESCRIPTION OF THE DRAWINGS

The features and nature of the present invention will become more apparent from the detailed description set forth below when taken in conjunction with the drawings in which like reference characters identify correspondingly throughout.

FIG. 1 shows a wireless multiple-access communication system.

FIG. 2 shows a terminal in soft handoff with two base stations on the reverse link (RL).

FIG. 3 shows RL soft handoff with a timely received assignment.

FIG. 4 shows RL soft handoff with a late received assignment.

FIG. 5 shows RL soft handoff with buffering at a SHO base station.

FIG. 6 shows H-ARQ transmission on the reverse link with soft handoff.

FIG. 7 shows RL soft handoff for an H-ARQ transmission.

FIG. 8 shows RL soft handoff for an H-ARQ transmission with buffering.

FIGS. 9A and 9B show decoding by the SHO base station for the H-ARQ transmission upon receiving the assignment and for a subsequent data block, respectively.

FIG. 10A shows processing by the terminal with over-the-air signaling.

FIG. 10B shows an apparatus for the processing shown in FIG. 10A.

FIG. 11A shows processing by the SHO base station with over-the-air signaling.

FIG. 11B shows an apparatus for the processing shown in FIG. 11A.

FIG. 12A shows processing by the serving base station with backhaul signaling.

FIG. 12B shows an apparatus for the processing shown in FIG. 12A.

FIG. 13A shows processing by the SHO base station with backhaul signaling.

FIG. 13B shows an apparatus for the processing shown in FIG. 13A.

FIG. 14 shows a block diagram of the terminal and two base stations.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

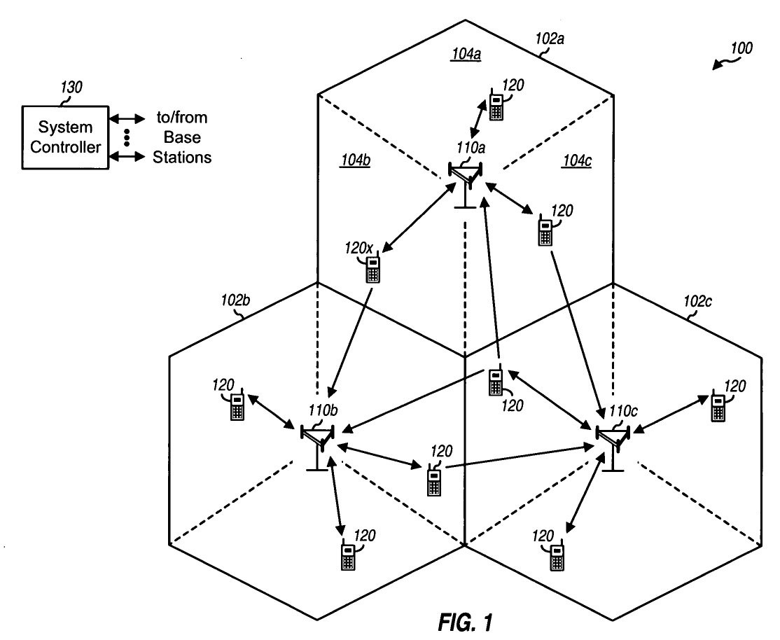

FIG. 1 shows a wireless multiple-access communication system 100 with multiple base stations 110 and multiple terminals 120. A base station is a station that communicates with the terminals and may also be called, and may contain some or all of the functionality of, an access point, a Node B, and/or some other network entity. Each base station 110 provides communication coverage for a particular geographic area 102. The term “cell” may refer to a base station and/or its coverage area depending on the context in which the term is used. To improve system capacity, a base station coverage area may be partitioned into multiple smaller areas, e.g., three smaller areas 104a, 104b, and 104c. Each smaller area is served by a respective base transceiver subsystem (BTS). The term “sector” can refer to a BTS and/or its coverage area depending on the context in which the term is used. For a sectorized cell, the BTSs for all sectors of that cell are typically co-located within the base station for the cell.

Terminals 120 are typically dispersed throughout the system, and each terminal may be fixed or mobile. A terminal may also be called, and may contain some or all of the functionality of, a mobile station, user equipment, and/or some other device. A terminal may be a wireless device, a cellular phone, a personal digital assistant (PDA), a wireless modem card, and so on. Each terminal may communicate with zero, one, or multiple base stations on the forward and/or reverse links at any given moment. For the embodiment shown in FIG. 1, each terminal 120 can communicate with one base station on the forward link and with one or multiple base stations on the reverse link.

For a centralized architecture, a system controller 130 couples to base stations 110 and provides coordination and control for these base stations. System controller 130 may be a single network entity or a collection of network entities. For example, system controller 130 may perform functions normally performed by a base station controller (BSC), a mobile switching center (MSC), a radio network controller (RNC), and/or some other network entity. For a distributed architecture, the base stations may communicate with one another as needed without the uses of system controller 130.

The techniques described herein may be used for a system with sectorized cells as well as a system with un-sectorized cells. In the following description, the term “soft handoff” covers both (1) a process in which a terminal concurrently communicates with multiple sectors of the same cell, which is commonly called “softer handoff”, and (2) a process in which a terminal concurrently communicates with multiple cells or sectors of multiple cells, which is commonly called “soft handoff”. In the following description, the term “base station” is used generically for a BTS that serves a sector as well as a base station that serves a cell.

In some embodiments, in order to facilitate soft handoff, multiple base stations or sectors thereof may allocate resources to each terminal prior to initiating communication with that terminal. This approach may allow for more efficient soft handoff, by having some parameters with respect to the terminal known at a base station or sector prior to initiation of communication with that base station or sector.

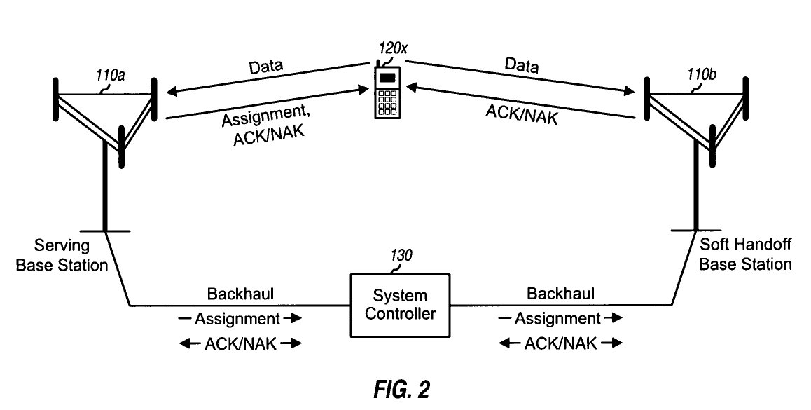

FIG. 2 shows a terminal 120x in soft handoff with two base stations 110a and 110b on the reverse link. For the example shown in FIG. 2, base station 110a is a serving base station and base station 110b is a soft handoff (SHO) base station. A serving base station is a base station that communicates with a terminal and in certain embodiments may also have been in communication with terminal 120x prior to initiation of communication between terminal 120x and SHO base station 110b. In some embodiments, the serving base station may assign air-link resources to the terminal, schedules the terminal for transmission on the forward and reverse links, and so on. In other embodiments, another base station may manage communication between serving base station 110a and terminal 120x. A SHO base station is a base station that communicates with a terminal for soft handoff. The serving and SHO base stations may also be referred to by some other terminology. A SHO terminal is a terminal that is in soft handoff.

In general, soft handoff may be initiated by a base station or a terminal. In some embodiments, the serving base station and/or other base stations (e.g., those in the terminal's active set) may initiate soft handoff based on (1) measurements (e.g., for received power, received signal quality, and so on) made by the base stations for the terminal, (2) information (e.g., channel quality indicator) sent by the terminal to the base stations, and/or (3) other information available to the base stations (e.g., processing resources available at the base stations). In other embodiments, the terminal may request or initiate soft handoff based on measurements made by the terminal, information received from the base stations, and/or other information available to the terminal.

In general, a terminal may be in soft handoff on the reverse link with any number of base stations. All of the base stations supporting soft handoff for the terminal may be included in an active set. This active set may be maintained and/or updated by the serving base station, the terminal, and/or some other network entity. The base stations in the active set may communicate with each other directly via a backhaul (not shown in FIG. 2) or indirectly via a backhaul and system controller 130 (as shown in FIG. 2). For clarity, much of the description below is for the scenario shown in FIG. 2 with terminal 120x communicating with two base stations 110a and 110b for soft handoff on the reverse link.

In system 100, the base stations in the active set may not know when a SHO terminal is transmitting on the reverse link. For example, each base station 110 may schedule terminals having that base station as the serving base station for transmission on the reverse link. Each base station may send an assignment via an over-the-air message to each terminal scheduled for transmission on the reverse link. The assignment may include pertinent parameters such as, e.g., the air-link resources (e.g., frequency, time and/or code) assigned to the terminal, the packet format to be used for transmission, and possibly other information. The packet format may indicate, e.g., the data rate, the coding and modulation, the packet size, and so on to use for transmission. If soft handoff is desired for a given terminal, then the SHO base stations in the active set can ascertain the pertinent parameters used by the terminal for transmission and can attempt to decode the transmission based on this knowledge. The SHO base stations may ascertain the pertinent parameters in various manners.

In an aspect, a SHO terminal sends over-the-air signaling that contains pertinent information for recovering the transmission sent on the reverse link. The pertinent information may be sent in a preamble of the transmission, in the transmission itself, in a message sent on a separate control channel, and so on. The information may be sent using the same multiple-access scheme (e.g., OFDMA or SC-FDMA) as the data transmission or a different multiple-access scheme (e.g., CDMA). Several aspects of such an approach are depicted and described in co-pending U.S. patent application Ser. No. 11/132,765, entitled “Softer And Soft Handoff In An Orthogonal Frequency Division Wireless Communication System,” which is incorporated herein by reference in its entirety. In any case, the information may be sent in a manner such that it can be recovered with high reliability by the SHO base stations.

In an embodiment, the pertinent information is conveyed in a preamble that is scrambled with a scrambling sequence specific to the SHO terminal. For example, each terminal may be assigned a MACID or some other unique identifier for a session. Each MACID may be associated with a different scrambling sequence, and each terminal may use the scrambling sequence for its MACID to scramble its preamble. A SHO base station may descramble a received preamble with different scrambling sequences for different MACIDs to identify the terminal that sent the preamble. The SHO base station may then obtain the pertinent information from the descrambled preamble and may use this information to demodulate and decode the transmission from the terminal.

If system 100 has multiple subbands, which is the case for an OFDMA or SC-FDMA system, then multiple terminals may be assigned different sets of subbands in a given scheduling interval. The subband sets may include the same or different numbers of subbands and may be static or dynamic (e.g., may change from scheduling interval to scheduling interval). A given terminal may be assigned different subband sets in different scheduling intervals. A SHO base station may evaluate different channel assignment hypotheses to search for the preambles sent by the terminals. For each scheduling interval, the SHO base station may evaluate each possible subband set (or channel assignment) that may be assigned in order to determine whether a transmission is being sent on that subband set. Whenever a preamble is detected for a given subband set, that subband set may be removed from the list of subbands to evaluate, and the subbands in the updated list may be evaluated.

In another aspect, the serving base station sends signaling for the terminal via the backhaul to all SHO base stations in the active set. The signaling, which may contain the assignment, may be sent via the backhaul in various manners.

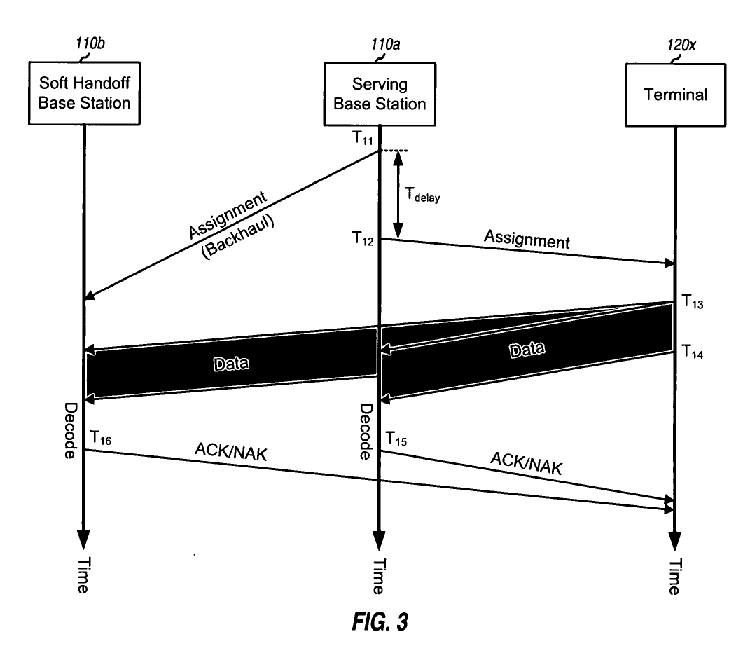

FIG. 3 shows an embodiment of soft handoff on the reverse link with the assignment being sent via the backhaul to SHO base station 110b prior to being sent over the air to terminal 120x. For this embodiment, serving base station 110a schedules terminal 120x for transmission on the reverse link and forms the assignment for the terminal. At time T₁₁, serving base station 110a sends the assignment via the backhaul to SHO base station 110b. At time T₁₂, which is a delay of T_{delay} after time T₁₁, serving base station 110a sends the assignment over the air to terminal 120x. The delay T_{delay} is such that SHO base station 110b can receive the assignment and perform any necessary preparation prior to the arrival of the transmission from terminal 120x.

Terminal 120x receives the assignment from serving base station 110a and sends a transmission on the reverse link starting at the scheduled time T₁₃. Each base station 110 receives and buffers the transmission from terminal 120x. At time T₁₄, terminal 120x terminates the transmission on the reverse link. The transmission from terminal 120x may carry coded data for a single packet or multiple packets. Each packet is encoded separately at terminal 120x and is intended to be decoded separately at each base station 110. If the transmission carries coded data for a single packet, then each base station 110 may decode the packet after receiving the entire transmission from terminal 120x, as indicated in FIG. 3. If the transmission carries coded data for multiple packets, then each base station 110 may decode each packet as soon as the entire packet is received (not shown in FIG. 3). Since a coded packet typically contains redundancy to improve reliability, each base station 110 may also attempt to decode the packet after receiving only a portion of the packet.

In any case, at time T₁₅, serving base station 110a sends an acknowledgment (ACK) if the transmission from terminal 120x is decoded correctly or a negative acknowledgment (NAK) if the transmission is decoded in error. At time T₁₆, SHO base station 110b sends an ACK or a NAK to terminal 120x based on the decoding result for base station 110b. In general, the transmission from SHO base station 110b may arrive earlier or later than the transmission from serving base station 110a at terminal 120x.

In general, the serving and SHO base stations may send ACKs and/or NAKs in various manners. In an embodiment, each base station individually sends ACKs and/or NAKs to the terminal based on its decoding results. For an ACK-based scheme, ACKs are explicitly sent, and NAKs are implicitly sent and presumed to have been sent by the absence of ACKs. For a NAK-based scheme, NAKs are explicitly sent, and ACKs are implicitly sent and presumed to have been sent by the absence of NAKs. The serving and SHO base stations may use the same or different ACK/NAK schemes. For example, the serving base station may explicitly send ACKs and NAKs while the SHO base stations may use an ACK-based scheme to reduce overhead on the forward link in the case of unsuccessful decoding. Each base station may send its ACK/NAK to the terminal using either uncoded signaling (e.g., binary ‘0’ for ACK and ‘1’ for NAK) or coded signaling. The coded signaling may improve reliability and facilitate ACK/NAK message decoding error detection. For example, the serving base station may send ACKs/NAKs using coded signaling and the SHO base stations may send ACKs/NAKs using uncoded signaling.

In an embodiment, the serving and SHO base stations in the active set exchange ACKs and/or NAKs for the terminal. For example, each base station may send its ACKs and/or NAKs to system controller 130, which may combine the ACKs and/or NAKs and then send the results to all base stations in the active set. System controller 130 may combine the ACKs and NAKs for each packet transmitted by the terminal. For example, if any base station in the active set decodes a packet correctly and sends an ACK to system controller 130, then system controller 130 may forward this ACK to all other base stations in the active set so that no base station thereafter attempts to decode this packet. This sharing of ACKs among the base stations in the active set can reduce error events and decoding attempts since each base station knows when to terminate the decoding of a prior packet and when to start the decoding of a new packet.

The embodiment shown in FIG. 3 allows the SHO base station to receive the assignment before the transmission from the terminal arrives. There is typically a “prep” delay between the time an assignment is sent to the terminal and the time the terminal starts transmission. If the delay in the backhaul is smaller than the prep delay, then the delay of T_{delay} is not needed. However, if the prep delay is shorter than the backhaul delay, then the scheduling delay (which is the difference between the time the terminal is scheduled and the time the terminal actually transmits) may, but need not, be increased by T_{delay} in order to ensure that the SHO base station can timely receive this assignment. It may be desirable to reduce or eliminate this delay of T_{delay}.

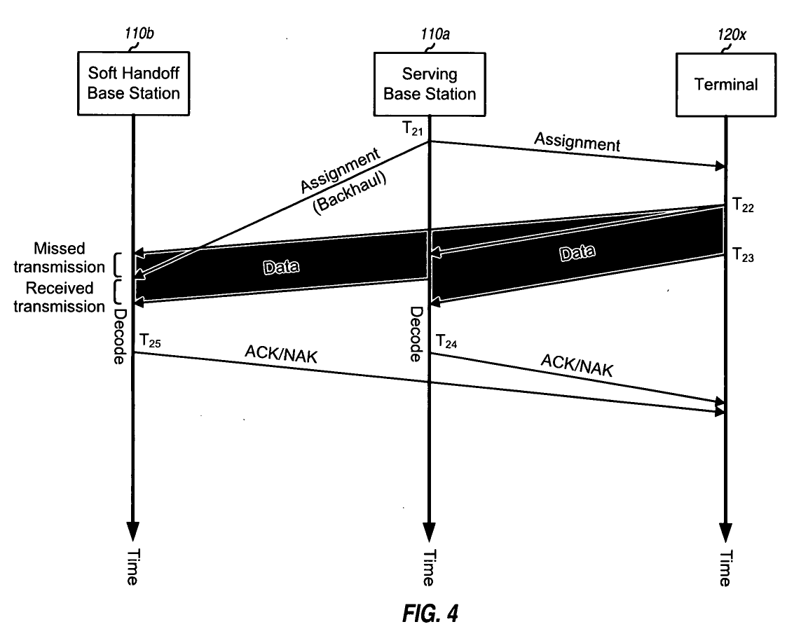

FIG. 4 shows an embodiment of soft handoff on the reverse link with the assignment being sent over the air to terminal 120x and also via the backhaul to SHO base station 110b at the same time. Serving base station 110a schedules terminal 120x for transmission on the reverse link and forms the assignment for the terminal. At time T₂₁, serving base station 110a sends the assignment over the air to terminal 120x and also via the backhaul to SHO base station 110b.

Terminal 120x receives the assignment and sends a transmission on the reverse link starting at the scheduled time T₂₂. Serving base station 110a receives and buffers the transmission from terminal 120x. For the example shown in FIG. 4, SHO base station 110b receives the assignment during the middle of the transmission because of delay in the backhaul. Upon receiving the assignment, SHO base station 110b receives and buffers the remaining transmission from terminal 120x. At time T₂₃, terminal 120x terminates the transmission on the reverse link. SHO base station 110b receives only a partial transmission from terminal 120x and misses the portion that was sent before the arrival of the assignment.

Serving base station 110a decodes the transmission from terminal 120x based on the entire transmission from terminal 120x. SHO base station 110b may decode the partial transmission received from terminal 120x. At time T₂₄, serving base station 110a sends an ACK or a NAK to terminal 120x based on its decoding result. At time T₂₅, SHO base station 110b may send an ACK or a NAK to terminal 120x based on its decoding result. The serving and SHO base stations may send ACKs and/or NAKs to the terminal and/or exchange the ACKs and/or NAKs among themselves in various manners, as described above for FIG. 3.

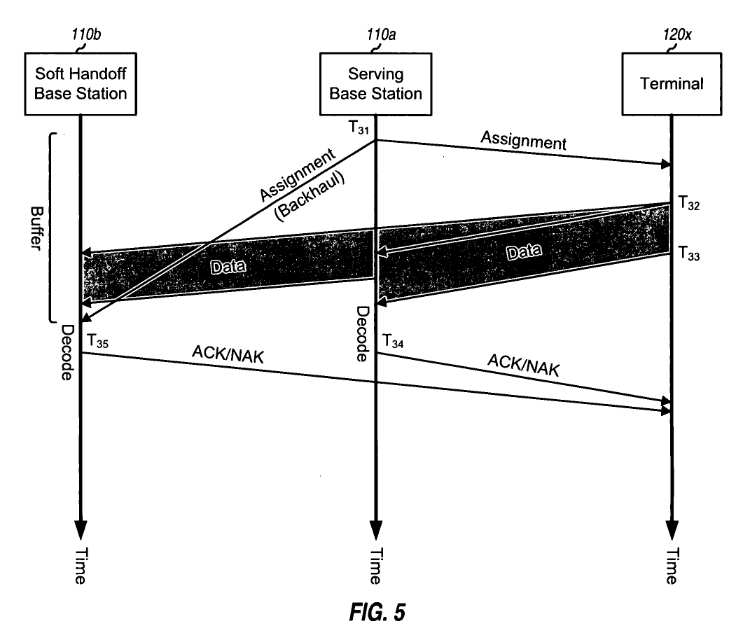

FIG. 5 shows an embodiment of soft handoff on the reverse link with buffering at SHO base station 110b. Serving base station 110a schedules terminal 120x for transmission on the reverse link, forms the assignment for terminal 120x, and at time T₃₁ sends the assignment over the air to terminal 120x and also via the backhaul to SHO base station 110b. Terminal 120x receives the assignment and sends a transmission on the reverse link starting at the scheduled time T₃₂. Serving base station 110a receives and buffers the transmission from terminal 120x. At time T₃₃, terminal 120x terminates the transmission on the reverse link. Serving base station 110a decodes the transmission from terminal 120x, e.g., upon receiving the entire transmission from terminal 120x. At time T₃₄, serving base station 110a sends an ACK or a NAK to terminal 120x based on its decoding result.

For the example shown in FIG. 5, SHO base station 110b receives the assignment after the entire transmission has been sent by terminal 120x because of backhaul delay. However, SHO base station 110b buffers its received signal in anticipation of possible late arrival of assignments for SHO terminals. Upon receiving the assignment for terminal 120x, SHO base station 110b retrieves and decodes the buffered transmission for terminal 120x. At time T₃₅, SHO base station 110b may send an ACK or a NAK to terminal 120x based on its decoding result. The serving and SHO base stations may send ACKs and/or NAKs to the terminal and/or exchange the ACKs and/or NAKs among themselves in various manners, as described above for FIG. 3.

SHO base station 110b may buffer its received signal for an amount of time corresponding to the longest expected backhaul delay for the assignment. The transmission time line in the system may be partitioned into time slots (or frames), with each time slot being of a predetermined time duration. The transmissions from the terminals may be sent in time slots. In this case, SHO base station 110b may buffer its received signal for a duration of L time slots, where the number of buffered time slots (L) is greater than the longest expected backhaul delay for all base stations participating in soft handoff.

The buffered signal for SHO base station 110b contains the transmissions from all terminals transmitting to base station 110b. Thus, the buffering requirement for SHO base station 110b is not too great since the transmissions from the terminals do not need to be buffered separately. The buffered signal may be demodulated and decoded for any terminal upon receiving its assignment.

The soft handoff techniques described herein may be used for a hybrid automatic repeat request (H-ARQ) transmission, which is also called an incremental redundancy (IR) transmission. For H-ARQ, a packet may be transmitted in one or more blocks until the packet is decoded correctly or the maximum number of blocks have been sent for the packet. H-ARQ improves reliability for data transmission and supports rate adaptation for packets in the presence of changes in the channel conditions.

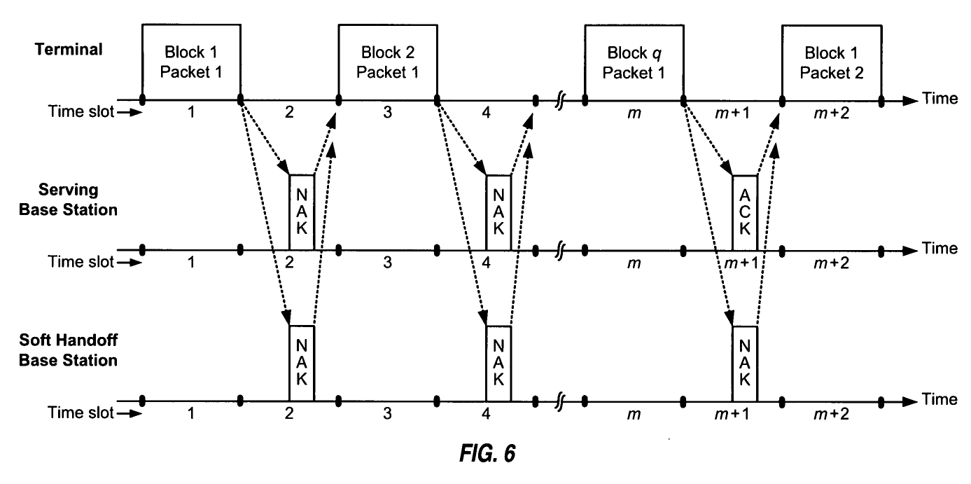

FIG. 6 illustrates H-ARQ transmission on the reverse link with soft handoff. A terminal processes (e.g., encodes and modulates) a packet (Packet 1) and generates multiple (Q) data blocks. A data block may also be called a frame, a subpacket, or some other terminology. Each data block may contain sufficient information to allow a base station to correctly decode the packet under favorable channel conditions. The Q data blocks contain different redundancy information for the packet. For the example shown in FIG. 6, each data block is sent in one time slot.

The terminal transmits the first data block (Block 1) for Packet 1 in time slot 1. Each base station in soft handoff or active communication with the terminal demodulates and decodes Block 1, determines that Packet 1 is decoded in error, and sends a NAK to the terminal in time slot 2. The terminal receives the NAKs from the base stations and transmits the second data block (Block 2) for Packet 1 in time slot 3. Each base station receives Block 2, demodulates and decodes Blocks 1 and 2, determines that Packet 1 is still decoded in error, and sends a NAK in time slot 4. The block transmission and NAK response may continue for any number of times. For the example shown in FIG. 6, the terminal transmits data block q (Block q) for Packet 1 in time slot m, where q≦Q. The serving base station receives Block q, demodulates and decodes Blocks 1 through q for Packet 1, determines that the packet is decoded correctly, and sends an ACK in time slot m+1. The terminal receives the ACK from the serving base station and terminates the transmission of Packet 1. The terminal processes the next packet (Packet 2) and transmits the data blocks for Packet 2 in similar manner.

In FIG. 6, there is a delay of one time slot for the ACK/NAK response for each block transmission. To improve channel utilization, the terminal may transmit multiple packets in an interlaced manner. For example, the terminal may transmit one packet in odd-numbered time slots and another packet in even-numbered time slots. More than two packets may also be interlaced for a longer ACK/NAK delay.

For clarity, FIG. 6 shows the base stations sending ACKs and NAKs to the terminal. As noted above, the base stations may send ACKs and/or NAKs to the terminal and among themselves in various manners.

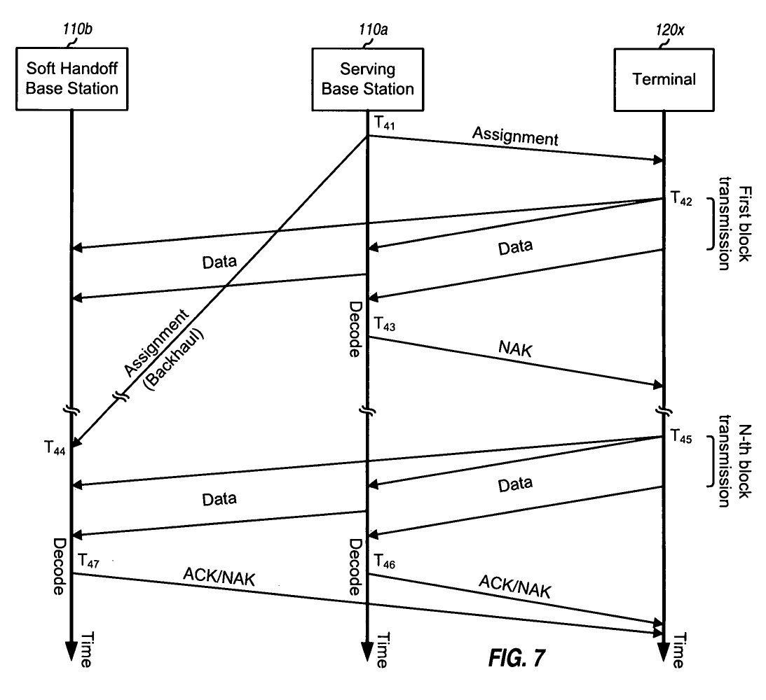

FIG. 7 shows an embodiment of soft handoff on the reverse link for an H-ARQ transmission. Serving base station 110a schedules terminal 120x for transmission on the reverse link, forms an assignment for terminal 120x, and at time T₄₁ sends the assignment over the air to terminal 120x and also via the backhaul to SHO base station 110b. Terminal 120x receives the assignment, processes a packet to generate multiple (Q) data blocks, and sends the first data block on the reverse link in the scheduled time slot starting at time T₄₂. Serving base station 110a receives and decodes the first data block, determines that the packet is decoded in error, and sends a NAK to terminal 120x at time T₄₃. The data block transmission by terminal 120x and the decoding by serving base station 110a may repeat for any number of times, as described above for FIG. 6.

For the example as shown in FIG. 7, SHO base station 110b receives the assignment at time T₄₄ because of backhaul delay. Time T₄₄ is after the first data block transmission and prior to the N-th data block transmission by terminal 120x, where 1<N≦Q. Upon receiving the assignment for terminal 120x, SHO base station 110b receives and decodes subsequent data blocks sent by terminal 120x based on the assignment.

Terminal 120x sends the N-th data block on the reverse link in the time slot starting at time T₄₅. Serving base station 110a receives the N-th data block, decodes the first through N-th data blocks, and sends an ACK or a NAK to terminal 120x at time T₄₆ based on its decoding result. SHO base station 110b receives and decodes the N-th data block and sends an ACK or a NAK to terminal 120x at time T₄₇ based on its decoding result. The serving and SHO base stations may send ACKs and/or NAKs to the terminal and/or exchange the ACKs and/or NAKs among themselves in various manners, as described above for FIG. 3.

In general, SHO base station 110b is able to start decoding the transmission from terminal 120x upon receiving the assignment for the terminal. If the backhaul delay is short and the assignment is received before terminal 120x finishes the first data block transmission (e.g., as shown in FIG. 4), then SHO base station 110b can attempt to decode the first data block from the terminal. If the backhaul delay is longer and the assignment is received after the first data block has been sent (e.g., as shown in FIG. 7), then SHO base station 110b can decode subsequent data blocks sent by terminal 120x. SHO base station 110b would not have the benefits of the data blocks sent prior to the arrival of the assignment, if these data blocks are not buffered. However, the soft handoff gain may still be valuable if the packet transmission is not terminated prior to the arrival of the assignment.

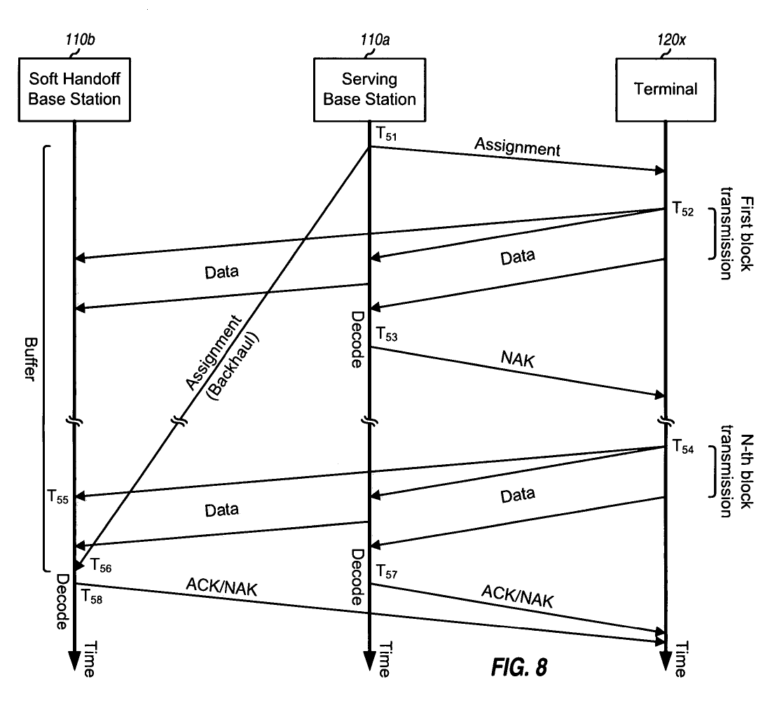

FIG. 8 shows an embodiment of soft handoff on the reverse link for an H-ARQ transmission with buffering at SHO base station 110b. Serving base station 110a schedules terminal 120x for transmission on the reverse link, forms an assignment for terminal 120x, and at time T₅₁ sends the assignment over the air to terminal 120x and also via the backhaul to SHO base station 110b. Terminal 120x receives the assignment, processes a packet to generate multiple (Q) data blocks, and sends the first data block on the reverse link in the scheduled time slot starting at time T₅₂. Serving base station 110a receives and decodes the first data block, determines that the packet is decoded in error, and sends a NAK to terminal 120x at time T₅₃. The data block transmission by terminal 120x and the decoding by serving base station 110a may repeat for any number of times, as described above for FIG. 6.

For the example shown in FIG. 8, SHO base station 110b receives the assignment at time T₅₆ after the N-th data block has been sent by terminal 120x because of backhaul delay, where in general 1<N≦Q. However, SHO base station 110b buffers its received signal in anticipation of possible late arrival of assignments for SHO terminals. Upon receiving the assignment for terminal 120x, SHO base station 110b retrieves and decodes the buffered data blocks for terminal 120x based on the assignment. SHO base station 110b may perform decoding for terminal 120x in various manners.

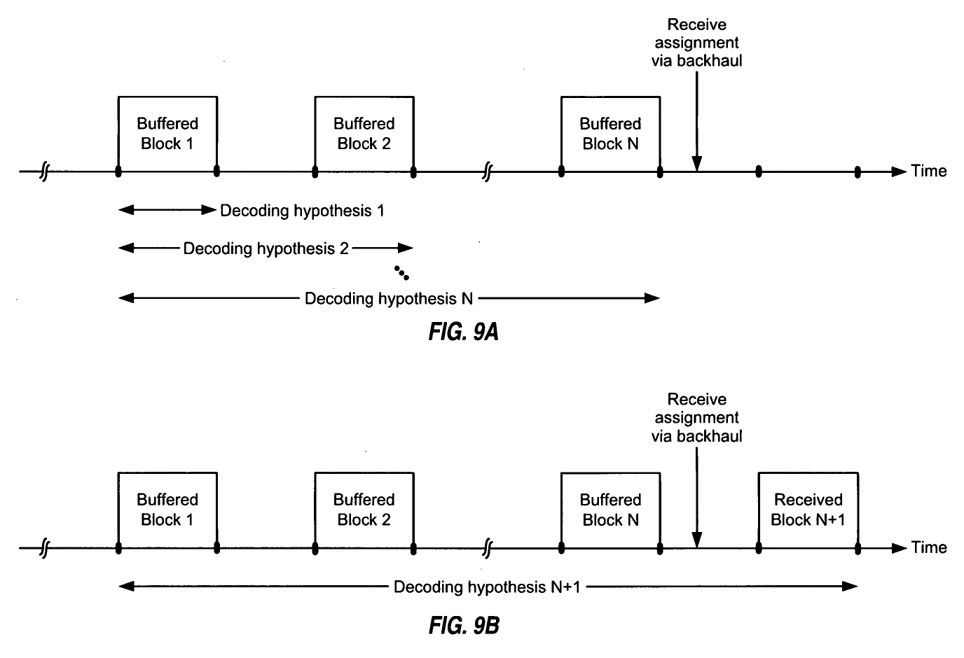

FIG. 9A shows an embodiment for performing decoding by SHO base station 110b based on buffered data. The assignment received by SHO base station 110b for terminal 120x may indicate the start of the packet sent by terminal 120x. In this case, SHO base station 110b can ascertain the first data block for the packet based on the assignment. However, SHO base station 110b may not know if or when the packet is terminated. SHO base station 110b may then perform decoding for multiple hypotheses to try to recover the packet sent by terminal 120x. For the first decoding hypothesis, SHO base station 110b may assume that only one data block has been sent for the packet and may decode the first data block sent by terminal 120x, which is data block 1 for the example shown in FIGS. 8 and 9A. If the packet is decoded correctly, then SHO base station 110b terminates the decoding of the packet and generates an ACK for the packet. Otherwise, if the packet is decoded in error, then for the second decoding hypothesis, SHO base station 110b may assume that two data blocks have been sent by terminal 120x and may decode data blocks 1 and 2 sent by terminal 120x. The decoding may continue until the packet is decoded correctly, all buffered data blocks have been used for decoding, or the maximum number of (Q) data blocks has been used for decoding. If all buffered data blocks have been used for decoding and the packet is still decoded in error but the maximum number of data blocks have not been sent by terminal 120x, then SHO base station 110b waits for the next block transmission from terminal 120x.

Referring back to FIG. 8, after processing the N-th data block, serving base station 110a may send an ACK or a NAK to terminal 120x at time T₅₇ based on its decoding result. At time T₅₈, SHO base station 110b may send an ACK or a NAK to terminal 120x based on its decoding result. The serving and SHO base stations may send ACKs and/or NAKs to the terminal and/or exchange the ACKs and/or NAKs among themselves in various manners, as described above for FIG. 3. The exchange of ACKs among the base stations in the active set is especially desirable for an H-ARQ transmission with buffering at SHO base station 110b. The exchanged ACKs reduce error events and the number of decoding attempts by SHO base station 110b.

SHO base station 110b may receive and decode each subsequent data block sent by terminal 120x based on all data blocks received for terminal 120x.

FIG. 9B shows an embodiment for performing decoding by SHO base station 110b for each subsequent data block received from terminal 120x after obtaining the assignment. Whenever a new data block is received for a packet that has not been decoded correctly, SHO base station 110b may perform decoding based on all data blocks received for the packet. SHO base station 110b may generate and send an ACK if the packet is decoded correctly and may generate and send a NAK otherwise.

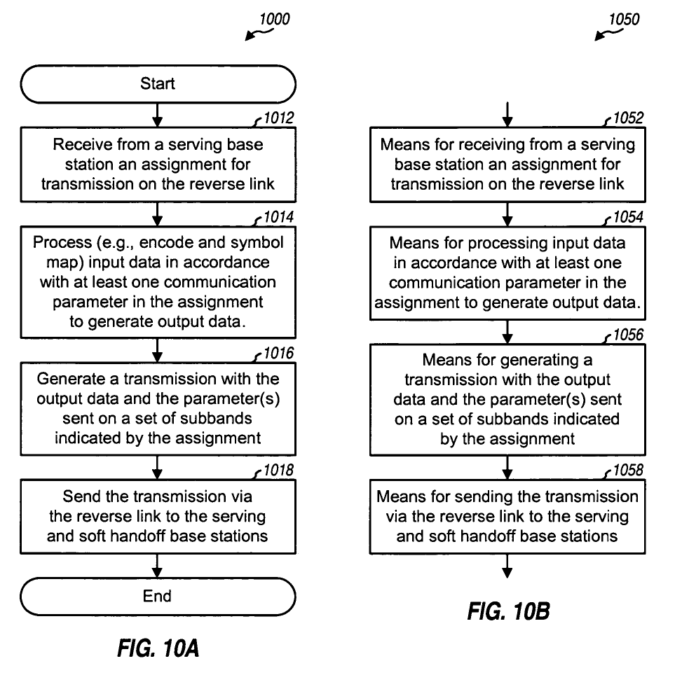

FIG. 10A shows an embodiment of a process 1000 performed by a terminal for soft handoff on the reverse link with over-the-air signaling. For this embodiment, the terminal transmits signaling along with data on its time-frequency allocation. The signaling may be used by a SHO base station to recover the data transmission from the terminal.

The terminal receives from the serving base station an assignment indicative of at least one communication parameter (e.g., a packet format) and a set of subbands to use for transmission on the reverse link (block 1012). The terminal processes (e.g., encodes and symbol maps) input data in accordance with the communication parameter(s) and generates output data (block 1014). The terminal generates a transmission with the output data and the communication parameter(s) sent on the assigned set of subbands (block 1016). For example, the terminal may scramble the communication parameter(s) with a scrambling sequence for the terminal, form a preamble with the scrambled parameter(s), and generate the transmission with the preamble and the output data. The terminal then sends the transmission via the reverse link to the serving and SHO base stations (block 1018). The signaling may comprise the preamble and/or other information used to recover the transmission sent by the terminal.

FIG. 10B shows an embodiment of an apparatus 1100 suitable for a terminal and supporting soft handoff on the reverse link with over-the-air signaling. Apparatus 1100 includes means for receiving from the serving base station an assignment for transmission on the reverse link (block 1052), means for processing (e.g., encoding and symbol mapping) input data in accordance with the communication parameter(s) in the assignment and generating output data (block 1054), means for generating a transmission with the output data and the communication parameter(s) sent on an assigned set of subbands (block 1056), and means for sending the transmission via the reverse link to the serving and SHO base stations (block 1058). Each of the means for elements may be implemented with hardware, firmware, software, or a combination thereof.

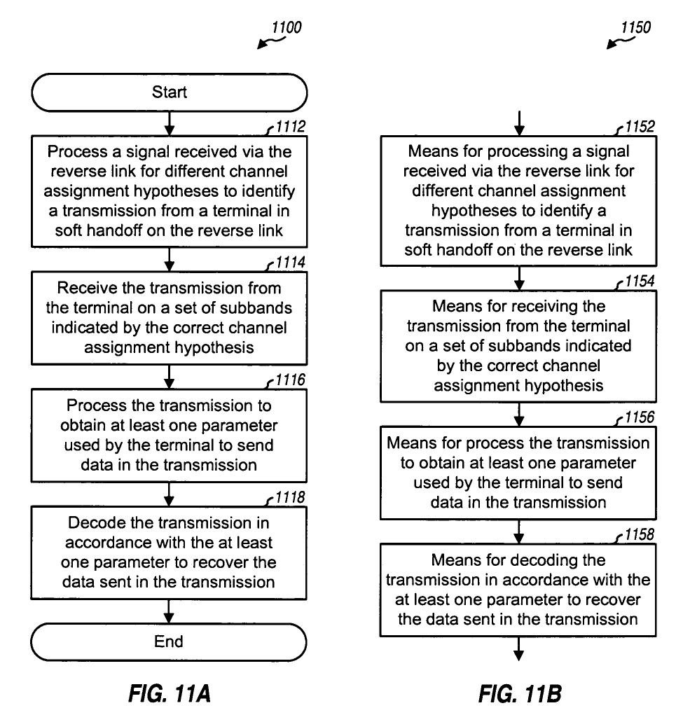

FIG. 11A shows an embodiment of a process 1100 performed by a SHO base station for soft handoff on the reverse link with over-the-air signaling. This embodiment is for the case in which a terminal sends signaling along with data on its time-frequency allocation, e.g., as shown in FIG. 10A. The SHO base station processes a signal received via the reverse link for different channel assignment hypotheses to identify a transmission from a terminal that is in soft handoff (block 1112). Each channel assignment hypothesis may correspond to a possible assignment of air-link resources (e.g., a possible time and frequency allocation) for the terminal. For each channel assignment hypothesis, the SHO base station may perform descrambling with different scrambling sequences to identify the transmission from the terminal. After identifying the transmission from the terminal, the SHO base station receives the transmission on the set of subbands indicated by the correct channel assignment hypothesis (block 1114). The SHO base station then processes the transmission to obtain at least one communication parameter used by the terminal to send data in the transmission (block 1116). The SHO base station then decodes the transmission in accordance with the at least one communication parameter to recover the data sent in the transmission (block 1118).

FIG. 11A shows an embodiment in which the detection of signaling sent by the terminal is performed in multiple stages because the SHO base station does not know the channel assignment for the terminal. In another embodiment, the terminal sends signaling via a CDMA channel or some other channel that is known a priori by the SHO base station. The signaling may indicate the channel assignment (time-frequency allocation) and the packet format used by the terminal.

FIG. 11B shows an embodiment of an apparatus 1150 suitable for a SHO base station and supporting soft handoff on the reverse link with over-the-air signaling. Apparatus 1150 includes means for processing a signal received via the reverse link for different channel assignment hypotheses to identify a transmission from a terminal that is in soft handoff (block 1152), means for receiving the transmission on the set of subbands indicated by the correct channel assignment hypothesis (block 1154), means for processing the transmission to obtain at least one communication parameter used by the terminal to send data in the transmission (block 1156), and means for decoding the transmission in accordance with the communication parameter(s) to recover the data sent in the transmission (block 1158). Each of the means for elements may be implemented with hardware, firmware, software, or a combination thereof.

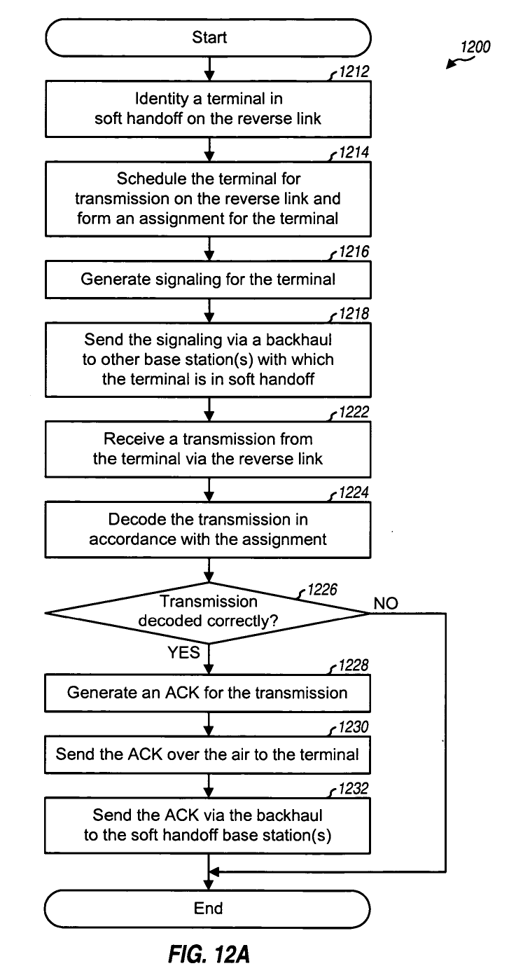

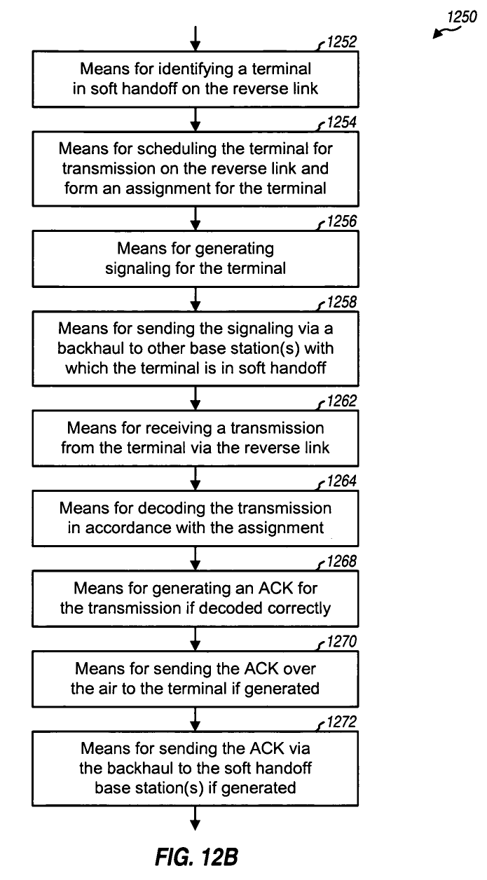

FIG. 12A shows an embodiment of a process 1200 performed by a serving base station for soft handoff on the reverse link with backhaul signaling. The serving base station identifies a terminal that is in soft handoff on the reverse link (block 1212), schedules the terminal for transmission on the reverse link (block 1214), forms an assignment for the terminal (also block 1214), and generates signaling for the terminal (block 1216). The assignment indicates communication parameter(s) to be used by the terminal for transmission on the reverse link such as, e.g., the time and frequency allocation for the terminal, the coding and modulation to be used by the terminal, and so on. The signaling contains sufficient information to allow a SHO base station to receive and process the transmission from the terminal. The signaling may contain, e.g., the assignment. The serving base station sends the signaling via the backhaul to at least one SHO base station for the terminal (block 1218).

Thereafter, the serving base station receives the transmission from the terminal via the reverse link (block 1222) and decodes the transmission in accordance with the assignment (block 1224). If the transmission is decoded correctly (as determined in block 1226), then the serving base station may generate an ACK for the transmission (block 1228), send the ACK over the air to the terminal (block 1230), and send the ACK via the backhaul to the SHO base station(s) (block 1232). Although not shown in FIG. 12A, for an H-ARQ transmission, if a packet is decoded in error with the current transmission and if the maximum number of transmissions for the packet has not been sent, then the serving base station may go from block 1226 to block 1222 to receive and process the next transmission. If an ACK from another SHO base station is received, then the serving base station sends signaling to the terminal to stop additional HARQ transmission.

FIG. 12B shows an embodiment of an apparatus 1250 suitable for a serving base station and supporting soft handoff on the reverse link with backhaul signaling. Apparatus 1250 includes means for identifying a terminal that is in soft handoff on the reverse link (block 1252), means for scheduling the terminal for transmission on the reverse link and forming an assignment for the terminal (block 1254), means for generating signaling for the terminal (block 1256), means for sending the signaling via the backhaul to at least one SHO base station for the terminal (block 1258), means for receiving the transmission from the terminal via the reverse link (block 1262), means for decoding the transmission in accordance with the assignment (block 1264), means for generating an ACK for the transmission if decoded correctly (block 1268), means for sending the ACK over the air to the terminal if generated (block 1270), and means for sending the ACK via the backhaul to the SHO base station(s) if generated (block 1272). Each of the means for elements may be implemented with hardware, firmware, software, or a combination thereof.

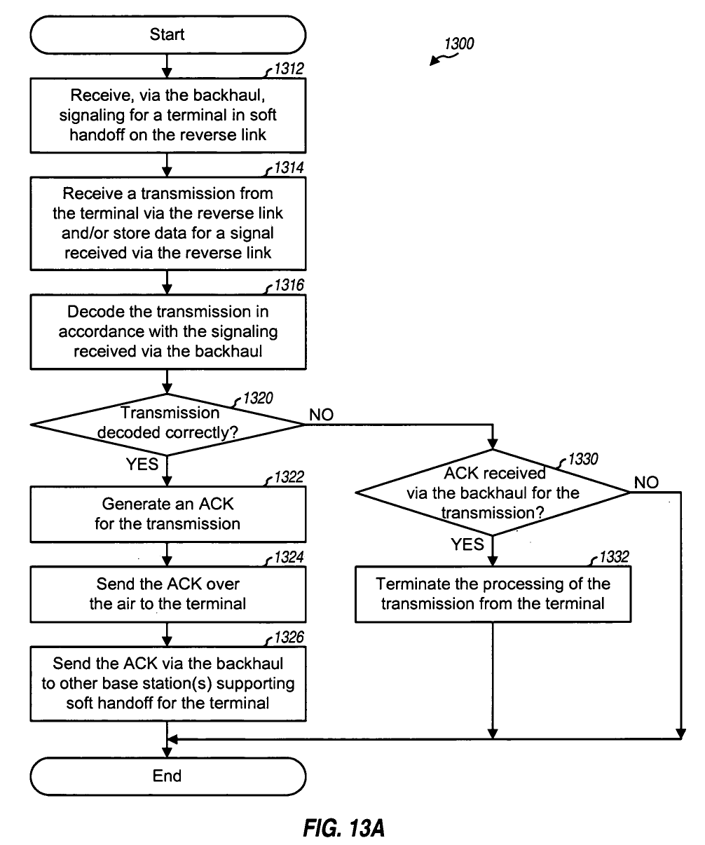

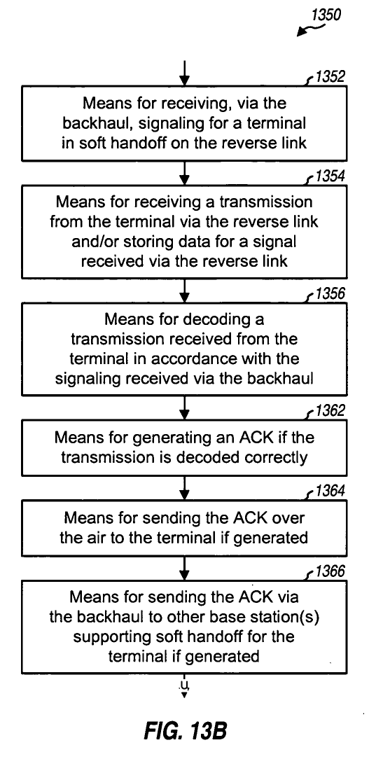

FIG. 13A shows an embodiment of a process 1300 performed by a SHO base station for soft handoff on the reverse link with backhaul signaling. The SHO base station receives, via the backhaul, signaling for a terminal that is in soft handoff on the reverse link (block 1312). The SHO base station receives a transmission from the terminal via the reverse link and/or stores a signal received via the reverse link (block 1314). The SHO base station decodes the transmission in accordance with the signaling to recover data sent in the transmission (block 1316). The decoding may be performed in various manners depending on (1) whether the signaling is received before or after the transmission from the terminal, (2) whether the received signal for the SHO base station is buffered, (3) whether the transmission from the terminal is an H-ARQ transmission, and (4) possibly other factors.

If the signaling is received prior to the transmission from the terminal, then no buffering of the received signal is needed, and the transmission from the terminal may be processed upon being received, e.g., as shown in FIG. 3. If the signaling is received after the transmission has commenced, then a portion of the transmission is received and may be processed, e.g., as shown in FIG. 4. Alternatively, the received signal may be buffered, and the transmission from the terminal may be processed upon receiving the signaling, e.g., as shown in FIG. 5.

If the transmission from the terminal is an H-ARQ transmission, then data block(s) received for the transmission may be processed to recover the data sent in the transmission. If the signaling is received after at least one data block has been sent, then subsequent data block(s) may be processed as they are received to recover the data sent in the transmission, e.g., as shown in FIG. 7. Alternatively, the received signal may be buffered, and different decoding hypotheses may be attempted upon receiving the signaling, e.g., as shown in FIGS. 8 and 9A. Each decoding hypothesis corresponds to a different assumption of data blocks sent in the transmission. For example, the first decoding hypothesis may correspond to a single data block being sent in the transmission, and each subsequent decoding hypothesis may correspond to an additional data block being sent in the transmission.

In any case, if the transmission is decoded correctly, as determined in block 1320, then the SHO base station may generate an ACK for the transmission (block 1322), send the ACK over the air to the terminal (block 1324), and send the ACK via the backhaul to other base station(s) supporting soft handoff for the terminal (block 1326). If an ACK is received via the backhaul for the transmission, as determined in block 1330, then the SHO base station terminates the processing of the transmission (block 1332). Although not shown in FIG. 13A, for an H-ARQ transmission, if a packet is decoded in error with the current transmission and if the maximum number of transmissions for the packet has not been sent, then the SHO base station may go from block 1330 to block 1314 to receive and process the next transmission.

FIG. 13B shows an embodiment of an apparatus 1350 suitable for a SHO base station and supporting soft handoff on the reverse link with backhaul signaling. Apparatus 1350 includes means for receiving, via the backhaul, signaling for a terminal that is in soft handoff on the reverse link (block 1352), means for receiving a transmission from the terminal via the reverse link and/or storing data for a signal received via the reverse link (block 1354), means for decoding the transmission in accordance with the signaling to recover data sent in the transmission (block 1356), means for generating an ACK for the transmission if decoded correctly (block 1362), means for send the ACK over the air to the terminal if generated (block 1364), and means for sending the ACK via the backhaul to other base station(s) supporting soft handoff for the terminal, if generated (block 1366). Each of the means for elements may be implemented with hardware, firmware, software, or a combination thereof.

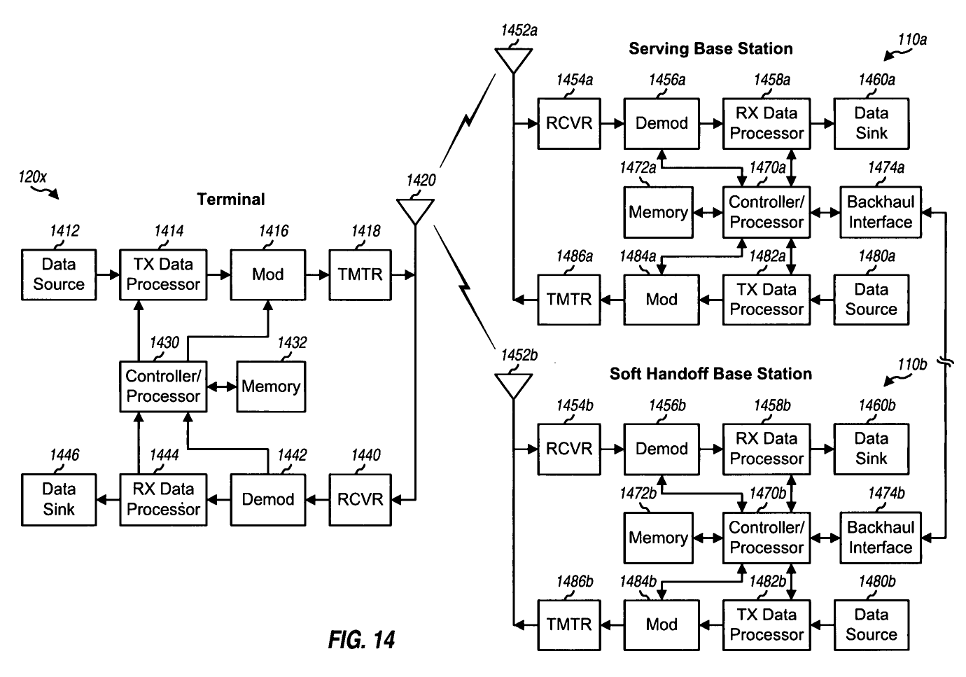

FIG. 14 shows a block diagram of an embodiment of base stations 110a and 110b and terminal 120x in system 100. At terminal 120x, a transmit (TX) data processor 1414 receives traffic data to be sent on the reverse link from data source 1412, processes (e.g., encodes, interleaves, and symbol maps) the traffic data based on one or more coding and modulation schemes, and provides data symbols, which are modulation symbols for traffic data. The coding and modulation may be performed based on an assignment received from serving base station 110a. A modulator (Mod) 1416 multiplexes data symbols with pilot symbols, which are modulation symbols for pilot. The multiplexing may be performed in accordance with the assignment from serving base station 110a. Modulator 1416 performs modulation on the multiplexed data and pilot symbols (e.g., for OFDM or SC-FDMA, as described below) and provides transmission symbols to a transmitter (TMTR) 1418. Transmitter 1418 processes (e.g., converts to analog, amplifies, filters, and upconverts) the transmission symbols and generates a reverse link modulated signal, which is transmitted from an antenna 1420.

At each base station 110, an antenna 1452 receives the reverse link modulated signals from terminal 120x and other terminals and provides a received signal to a receiver (RCVR) 1454. Receiver 1454 processes (e.g., amplifies, filters, downconverts, and digitalizes) the receive signal and provides received samples to a demodulator (Demod) 1456. Demodulator 1456 performs demodulation (e.g., for OFDM or SC-FDMA) on the received samples and provides received symbols for terminal 120x and other terminals transmitting on the reverse link. A receive (RX) data processor 1458 processes (e.g., symbol demaps, deinterleaves, and decodes) the received symbols for each terminal and provides decoded data to a data sink 1460. In general, the processing at each base station 110 is complementary to the processing at terminal 120x.

At each base station 110, traffic data from a data source 1480 and signaling (e.g., assignments, ACKs and/or NAKs) from a controller/processor 1470 may be processed by a TX data processor 1482, modulated by a modulator 1484, and conditioned by a transmitter 1486 to generate a forward link modulated signal, which is transmitted via antenna 1452. At terminal 120x, the forward link modulated signals from base stations 110a and 110b are received via antenna 1420, conditioned by a receiver 1440, demodulated by a demodulator 1442, and processed by an RX data processor 1444 to recover the traffic data and signaling sent to terminal 120x.

Controllers/processors 1430, 1470a and 1470b control the operation of various processing units at terminal 120x and base stations 110a and 110b, respectively. Memory units 1432, 1472a and 1472b store data and program codes used by terminal 120x and base stations 110a and 110b, respectively. Backhaul interfaces 1474a and 1474b allow base stations 110a and 110b, respectively, to communicate with system controller 130 and/or other network entities via the backhaul.

For reverse link soft handoff, serving base station 110a may schedule terminal 120x for transmission on the reverse link, generate an assignment for terminal 120x, and send the assignment over the air to terminal 120x and via the backhaul to SHO base station 110b. Serving base station 110a may process the transmission from terminal 120x as it is received via the reverse link. SHO base station 110b may store its received signal in memory 1472b until the assignment is received from serving base station 110a. Upon receiving the assignment for terminal 120x, base station 110b may process the transmission from terminal 120x based on the received and/or stored data.

For simplicity, FIG. 14 shows each of terminal 120x and base stations 110a and 110b being equipped with a single antenna. Each entity may also be equipped with multiple antennas that may be used for transmission and/or reception. A transmitting entity may perform transmitter spatial processing prior to transmitting from multiple antennas. A receiving entity may perform receiver spatial processing for a transmission received via multiple antennas. The spatial processing may be performed in various manners, as is known in the art.

The techniques described herein may be used for various wireless communication systems such as an OFDMA system, an SC-FDMA system, a frequency division multiple access (FDMA) system, a code division multiple access (CDMA) system, a time division multiple access (TDMA) system, and so on. An OFDMA system utilizes orthogonal frequency division multiplexing (OFDM), which is a multi-carrier modulation technique that partitions the overall system bandwidth into multiple (K) orthogonal subbands. These subbands are also called tones, subcarriers, bins, and so on. With OFDM, each subband is associated with a respective subcarrier that may be modulated with data. An SC-FDMA system may utilize interleaved FDMA (IFDMA) to transmit on subbands that are distributed across the system bandwidth, localized FDMA (LFDMA) to transmit on a group of adjacent subbands, or enhanced FDMA (EFDMA) to transmit on multiple groups of adjacent subbands. In general, modulation symbols are sent in the frequency domain with OFDM and in the time domain with SC-FDMA.

An OFDM symbol may be generated as follows. N modulation symbols are mapped to N subbands used for transmission (or N assigned subbands) and zero symbols with signal value of zero are mapped to the remaining K−N subbands. A K-point inverse fast Fourier transform (IFFT) or inverse discrete Fourier transform (IDFT) is performed on the K modulation symbols and zero symbols to obtain a sequence of K time-domain samples. The last C samples of the sequence are copied to the start of the sequence to form an OFDM symbol that contains K+C samples. The C copied samples are often called a cyclic prefix or a guard interval, and C is the cyclic prefix length. The cyclic prefix is used to combat intersymbol interference (ISI) caused by frequency selective fading, which is a frequency response that varies across the system bandwidth.

An SC-FDMA symbol may be generated as follows. N modulation symbols to be sent on N assigned subbands are transformed to the frequency domain with an N-point fast Fourier transform (FFT) or discrete Fourier transform (DFT) to obtain N frequency-domain symbols. The N frequency-domain symbols are mapped to the N assigned subbands, and zero symbols are mapped to the remaining K−N subbands. A K-point IFFT or IDFT is then performed on the K frequency-domain symbols and zero symbols to obtain a sequence of K time-domain samples. The last C samples of the sequence are copied to the start of the sequence to form an SC-FDMA symbol that contains K+C samples.

A transmission symbol may be an OFDM symbol or an SC-FDMA symbol. The K+C samples of a transmission symbol are transmitted in K+C sample/chip periods. A symbol period is the duration of one transmission symbol and is equal to K+C sample/chip periods.

OFDM and SC-FDMA demodulation may be performed in the manners known in the art.

The techniques described herein may be implemented by various means. For example, these techniques may be implemented in hardware, firmware, software, or a combination thereof. For a hardware implementation, the processing units at a base station may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. The processing units at a terminal may also be implemented within one or more ASICs, DSPs, processors, and so on.

For a firmware and/or software implementation, the transmission techniques may be implemented with modules (e.g., procedures, functions, and so on) that perform the functions described herein. The software codes may be stored in a memory and executed by a processor. The memory may be implemented within the processor or external to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus comprising:
an interface unit configured to receive, via a backhaul, signaling for a terminal in soft handoff on a reverse link of a communication system; and
at least one processor configured to decode a transmission received from the terminal in accordance with the signaling to recover data sent in the transmission.
The apparatus of claim 1, wherein the signaling comprises information indicative of a packet format of the transmission.

2. The apparatus of claim 1, wherein the interface unit is configured to receive the signaling prior to arrival of the transmission from the terminal.

3. The apparatus of claim 1, wherein the at least one processor is configured to decode a portion of the transmission, received after receipt of the signaling, in accordance with the signaling to recover the data sent in the transmission.

4. The apparatus of claim 1, wherein the transmission from the terminal comprises multiple data blocks, and wherein the at least one processor is configured to decode at least one of the multiple data blocks, received after receipt of the signaling, to recover the data sent in the transmission.

5. The apparatus of claim 1, further comprising:
a memory configured to store data for a signal received via the reverse link, wherein the received signal comprises the transmission from the terminal.

6. The apparatus of claim 5, wherein the at least one processor is configured to decode the data stored in the memory in accordance with the signaling to recover the data sent in the transmission.

7. The apparatus of claim 5, wherein the transmission from the terminal comprises at least one data block, and wherein the at least one processor is configured to decode the data stored in the memory for the at least one data block to recover the data sent in the transmission.

8. The apparatus of claim 5, wherein the at least one processor is configured to decode the data stored in the memory based on at least one decoding hypothesis to recover data sent in the transmission, wherein the transmission from the terminal comprises at least one data block, and wherein each decoding hypothesis corresponds to a different assumption of data blocks sent in the transmission.

9. The apparatus of claim 8, wherein the at least one processor is configured to perform decoding for the at least one decoding hypothesis in a sequential order, starting with a first decoding hypothesis corresponding to a single data block being sent in the transmission, and wherein each subsequent decoding hypothesis corresponds to an additional data block being sent in the transmission. Sending and Receiving ACKs

10. The apparatus of claim 1, wherein the at least one processor is configured to generate an acknowledgment (ACK) if the transmission is decoded correctly.

11. The apparatus of claim 10, wherein the at least one processor is configured to send the ACK to the terminal.

12. The apparatus of claim 10, wherein the interface unit is configured to send the ACK via the backhaul.

13. The apparatus of claim 1, wherein the at least one processor is configured to terminate decoding of the transmission if an acknowledgment (ACK) is received via the backhaul for the transmission.

14. The apparatus of claim 1, wherein the at least one processor is configured to perform orthogonal frequency division multiplexing (OFDM) demodulation for the transmission received from the terminal.

15. The apparatus of claim 1, wherein the at least one processor is configured to perform single-carrier frequency division multiple access (SC-FDMA) demodulation for the transmission received from the terminal.

16. A method comprising:
receiving, via a backhaul, signaling for a terminal in soft handoff on a reverse link of a communication system; and
decoding a transmission received from the terminal in accordance with the signaling to recover data sent in the transmission.

17. The method of claim 16, further comprising:
storing data for a signal received via the reverse link, wherein the received signal comprises the transmission from the terminal, and wherein the decoding the transmission comprises decoding the data stored in the memory in accordance with the signaling to recover the data sent in the transmission.

18. The method of claim 16, further comprising:
if the transmission is decoded correctly, generating an acknowledgment (ACK) for the transmission and sending the ACK to the terminal.

19. An apparatus comprising:
means for receiving, via a backhaul, signaling for a terminal in soft handoff on a reverse link of a communication system; and
means for decoding a transmission received from the terminal in accordance with the signaling to recover data sent in the transmission.

20. The apparatus of claim 19, further comprising:
means for storing data for a signal received via the reverse link, wherein the received signal comprises the transmission from the terminal, and wherein the means for decoding the transmission comprises means for decoding the data stored in the memory in accordance with the signaling to recover the data sent in the transmission.

21. The apparatus of claim 19, further comprising:
means for generating an acknowledgment (ACK) if the transmission is decoded correctly; and
means for sending the ACK to the terminal if generated.

22. An apparatus comprising:
at least one processor configured to identify a terminal in soft handoff on a reverse link with multiple base stations and to generate signaling for the terminal; and
an interface unit configured to send the signaling via a backhaul to at least one base station among the multiple base stations. Signaling

23. The apparatus of claim 22, wherein the signaling is indicative of a time and frequency allocation for the terminal.

24. The apparatus of claim 22, wherein the signaling is indicative of coding and modulation to be used by the terminal for transmission on the reverse link.

25. The apparatus of claim 22, further comprising:
at least one transmitter configured to send an assignment to the terminal after the interface unit has sent the signaling via the backhaul.

26. The apparatus of claim 22, further comprising:
at least one transmitter configured to send an assignment to the terminal concurrent with the interface unit sending the signaling via the backhaul.

27. The apparatus of claim 22, wherein the at least one processor is configured to receive a transmission from the terminal via the reverse link and to decode the transmission in accordance with an assignment for the terminal.

28. The apparatus of claim 27, wherein the at least one processor is configured to generate an acknowledgment (ACK) for the transmission if decoded correctly and to send the ACK to the terminal if generated.

29. The apparatus of claim 28, wherein the interface unit is configured to send the ACK via the backhaul.

30. The apparatus of claim 28, wherein the at least one processor is configured to initiate soft handoff for the terminal.

31. A method comprising:
identifying a terminal in soft handoff on a reverse link with multiple base stations;
generating signaling for the terminal; and
sending the signaling via a backhaul to at least one base station among the multiple base stations.

32. The method of claim 31, further comprising:
receiving a transmission from the terminal via the reverse link;
decoding the transmission in accordance with an assignment;
generating an acknowledgment (ACK) for the transmission if decoded correctly; and
sending the ACK to the terminal if generated.

33. An apparatus comprising:
means for identifying a terminal in soft handoff on a reverse link with multiple base stations;
means for generating signaling for the terminal; and
means for sending the signaling via a backhaul to at least one base station among the multiple base stations.

34. The apparatus of claim 33, further comprising:
means for receiving a transmission from the terminal via the reverse link;
means for decoding the transmission in accordance with an assignment;
means for generating an acknowledgment (ACK) for the transmission if decoded correctly; and
means for sending the ACK to the terminal if generated.

35. An apparatus comprising:
at least one receiver configured to receive a transmission from a terminal in soft handoff on a reverse link of a communication system, wherein the transmission is sent on a set of frequency subbands of a plurality of frequency subbands; and
at least one processor configured to process the transmission to obtain at least one communication parameter used by the terminal to send data in the transmission, and to decode the transmission in accordance with the at least one communication parameter to recover the data sent in the transmission.

36. The apparatus of claim 35, wherein the at least one processor is configured to process a signal received via the reverse link for a plurality of channel assignment hypotheses to identify the transmission from the terminal.

37. The apparatus of claim 36, wherein for each of the plurality of channel assignment hypotheses the at least one processor is configured to perform descrambling with a plurality of scrambling sequences to identify the transmission from the terminal.

38. The apparatus of claim 35, wherein the at least one processor is configured to perform orthogonal frequency division multiplexing (OFDM) demodulation for the transmission from the terminal.

39. An apparatus comprising:
at least one processor configured to process input data in accordance with at least one communication parameter to generate output data, and to generate a transmission with the output data and the at least one communication parameter mapped to a set of frequency subbands from among a plurality of frequency subbands; and
at least one transmitter configured to send the transmission via a reverse link to a plurality of base stations.

40. The apparatus of claim 39, wherein the at least one processor is configured to receive from one of the plurality of base stations an assignment indicative of the at least one communication parameter and the set of frequency subbands to use for the transmission.

41. The apparatus of claim 39, wherein the at least one processor is configured to scramble the at least one communication parameter with a scrambling sequence, to form a preamble with the at least one scrambled communication parameter, and to generate the transmission with the preamble and the output data.

42. The apparatus of claim 39, wherein the at least one processor is configured to request soft handoff with the plurality of base stations.
